(19) United States
(12) Patent Application Publication
(10) Pub. No.: US 2024/0044439 A1
(43) Pub. Date: Feb. 8, 2024

(54) RADAR SYSTEM FOR LINERS

(71) Applicant: PIPETRONICS GMBH & CO. KG, Rohrbach (DE)

(72) Inventor: Christian NOLL, Limburgerhof (DE)

(21) Appl. No.: 17/453,286

(22) PCT Filed: May 4, 2020
(86) PCT No.: PCT/DE2020/100365

§ 371 Date: Dec. 2, 2021

(30) Foreign Application Priority Data
Mar. 5, 2019 (DE) 10 2019 111 498.5

(51) Int. Cl. F16L 55/48; G01S 13/84; G01S 13/88; G01S 13/44; G01S 13/58

(52) U.S. Cl. CPC F16L 55/48; G01S 13/84; G01S 13/881; G01S 13/4454; G01S 13/584; G01S 13/867

(57) ABSTRACT

The invention relates to a method for locating a mobile device in a conduit system by means of a radar system, said radar system comprising a base station and a transponder attached to the device, and the signals being modulated.

### FIELD OF THE INVENTION

The present invention relates to a method for locating a device by means of a radar system comprising a base station and an active transponder fitted to the device.

### BACKGROUND

Radar systems for measuring a distance and a speed of an object are known. For the measurement, a transponder is fastened to the object. In order to measure the distance and/or the speed, a signal is transmitted from a base station of the radar system to the transponder. In the transponder, the signal is frequency-modulated and transmitted back to the base station after the modulation. The distance and the speed of the object can be evaluated on the basis of an evaluation operation. Besides frequency modulation, amplitude modulation is known as well.

DE 10 2005 059 507 A1 teaches a method for a radar system in which an unmodulated signal is transmitted from a base station to a transponder. Said signal is phase-modulated by the transponder and passively transmitted back to the base station. Such a method is greatly influenced by backscattering objects, such that the signal transmitted back has a high degree of noise. Moreover, the range of passive measuring systems is greatly limited.

Methods for renovating conduit systems in which liquid or gaseous media are transported, for example, are known and described in many instances in the prior art.

By way of example, methods are known in which the sections of the conduit system which have a defect or damage are replaced by new sections. However, this is laborious and also not always possible.

Furthermore, the prior art discloses methods in which, for renovation of conduit systems, e.g. ducts and similar pipe systems, a flexible, curable layer impregnated with curable resin, said layer serving as a tubular liner, also referred to as liner, is inserted into the conduit system. After being inserted, the tubular liner is expanded, such that it nestles closely against the inner wall of the conduit system. The resin is subsequently cured.

The production of a tubular liner of this type is described in WO 95/04646 for example. Such a tubular liner usually comprises a light-nontransmissive outer protective film, an inner film that is transmissive at least to specific wavelength ranges of electromagnetic radiation, and also a curable layer impregnated with a resin and arranged between the inner film and the outer film.

The outer film tube is intended to prevent the resin used for impregnation from escaping from the curable layer and passing into the environment. This presupposes a good tightness and attachment of the outer film tube to the resin-impregnated curable layer.

WO 00/73692 A1 discloses a tubular liner comprising an inner film tube, a resin-impregnated fiber band as curable layer, and an outer tube laminated with a fiber nonwoven on its inner side.

Prior to curing, the tubular liners are inserted into the conduit system to be renovated and are inflated by means of a fluid, generally compressed air. For inflating the tubular liner, compressed air is applied to one opening end of the tubular liner in accordance with the prior art and the opposite opening end of the tubular liner is closed with a closure device, a so-called packer. In this case, said closure device comprises a hollow cylinder and a covering element that can close off the hollow cylinder.

A curing device is inserted into the tubular liner for the curing thereof, said curing device comprising a radiation source and being led through the tubular liner in order to activate or perform the curing of the curable layers of the tubular liner by means of the radiation energy. A complete curing of the tubular liners is of great importance here, that is to say that a specific amount of radiation energy has to be introduced into the tubular liner at every point thereof. In this case, the amount of radiation energy depends on the power output of the radiation sources and also the speed at which the latter are guided through the tubular liner.

For regulating the curing, it is therefore important to know the position of the device for curing in order to regulate the output of the radiation energy.

Furthermore, conduit systems generally comprise feed conduits or subsidiary ducts. These have to be exposed again after the tubular liner has been drawn in and cured. Devices comprising a robot arm with a drilling or milling device fitted there are generally used for this purpose.

For metrological detection of conduits and in particular for determining the position of the branch junctions, measuring devices in accordance with the prior art are usually inserted into the conduit before the tubular liner is drawn in, wherein the measuring device is moved through a conduit to be renovated either autonomously or with the aid of a cable, in particular a cable comprising Kevlar fibers and/or at least one hauling rope, and/or with the aid of a hauling rope.

The measuring device in accordance with the prior art here, usually by way of optical sensors, in particular camera recordings, detects the position of the branch junctions before the tubular liner is drawn in.

The term branch junctions hereinafter is intended to be understood broadly and to encompass lateral inlets, also referred to as pipe inlets or pipe branch junctions. If a branch junction is identified, in order to determine the position of the branch junction in the conduit recourse is had either to a rotational speed sensor, which counts the number of revolutions of the wheels of the measuring device, the measurement of the length of the cable or hauling rope for progressive movement, or a tape measure carried along by the curing device.

In this case, however, the position of the branch junction not only has to be established in relation to its distance with respect to one or both opening ends of the conduit, but also has to be detected in terms of its angular position. Angle-of-rotation sensors or gravitation sensors, for example, are used for this purpose.

What is problematic here is that the position of the branch junction has to be determinable in a reproducible manner. After the tubular liner has been drawn in and cured, an exposing device is inserted into the conduit. Said exposing device is then moved to the detected position of the cutout. Both during the first pass through the conduit by the measuring device and when the exposing device passes through the renovated conduit, errors can occur in the position determination for the respective devices: spinning wheels preventing a movement of the device even though the rotational speed sensors detect propulsion, cables and/or hauling ropes running skew, devices rotated relative to themselves, non-identical positionings with respect to the center point of the conduits, etc.

However, it is crucial that it is possible for the positions of the branch junctions to be detected with very high precision. Even minimal deviations can lead to damage to the conduit branching off and/or jeopardize the tightness of the conduit system. Owing to the large number of possible sources of error when detecting the position of a cutout and moving to it again after a tubular liner has been drawn in, cutouts for exposing the branch junctions are therefore produced manually. For this purpose, firstly a first cutout is produced at a safe distance from the walls of the branch junction and then said first cutout is lengthened manually until the wall of the branch junction is reached. The branch junction is subsequently exposed further.

### SUMMARY OF THE INVENTION

The invention is thus based on the object of providing a method which makes it possible to locate a device in a conduit system, and in a conduit system lined with a tubular liner, in a simple and unambiguously reproducible manner.

The object is achieved according to the invention by means of the features of the independent claims.

The method according to the invention for locating a movable device in a conduit system is carried out by a radar system that comprises a base station and an active transponder fitted to the device. The method comprises the following steps:
transmitting a periodic initial signal having a temporally variable frequency by means of the base station,
receiving the periodic initial signal by means of the transponder on the device,
modulating the initial signal in the transponder in order to obtain a locating signal, such that the amplitude of the initial signal oscillates periodically with a fixed amplitude modulation frequency,
transmitting the periodic locating signal by means of the transponder on the device,
receiving the locating signal by means of the base station, and
evaluating the locating signal by means of an analysis for periodic signals in order to locate the device in the conduit system.

What is achieved by modulating a fixed periodic frequency onto the amplitude of the initial signal is that the locating signal to be evaluated is outside a frequency of the backscattering objects. In this regard, the locating signal is isolated from a large portion of the natural noise and noise generated by passively reflecting surfaces in the surroundings. In particular, a frequency that is as far away from the frequency of the noise as possible can be chosen for the modulation.

Reducing natural noise is of importance precisely in a conduit system, which forms a confined geometric shape and possibly does not run exclusively straight, but rather in curved fashion, but often over hundreds of meters in length.

Furthermore, the base station can be part of an SISO, AoA, MiMO, digital beamforming or other imaging radar system. Furthermore, the starting bandwidth of the signal can be a plurality of megahertz. The base station is equipped with at least one transmitter and one receiver. The transmitter can generate the initial signal by means of a VCO oscillator (Voltage Controlled Oscillator). The transponder is likewise equipped with at least one transmitter and one receiver.

Such a method makes it possible for example to detect the position of a device in a tubular liner in a conduit that may be hundreds of meters away from the entry opening of the tubular liner, the conduit itself being curved, for example.

Advantageously, the amplitude of the initial signal is modulated by means of a high-purity sine or cosine in the transponder. The high-purity sine or cosine has a particularly fixed frequency, such that an unambiguous signal is obtained. This very pure signal can be modulated by the transponder, and be transmitted back to the base station again, where it can then be precisely analyzed by a simple electronic circuit.

Expediently, the base station emits the initial signal with an initial frequency having a linear temporal dependence, as is customary for traditional FMCW radars in radar technology. Alternatively, the initial frequency of the initial signal can also have other temporal dependencies, such as quadratic, cubic or other dependencies. Furthermore, instead of a frequency modulation, it is also possible to use other types of modulation (such as QPSK, OFDM, etc.) customary in telecommunications technology as the initial signal of the base station. Thus, optionally, a data transfer from the base station to the transponder can also be made possible in addition to the distance measurement. As a result of the temporal dependence, the initial frequency changes with time. By way of example, a frequency ramp can be traversed, such that the initial frequency of the initial signal changes according to the ramp gradient in relation to a frequency-time dependence. Since the initial signal has a temporally dependent initial frequency, the locating signal can also have a temporally dependent frequency corresponding to the initial frequency. A precise distance measurement can be carried out as a result.

It can be provided that the modulation in the transponder is effected by a first mixer of the transponder, which accepts the initial signal and amplitude-modulates it with a high-frequency constant amplitude modulation frequency in order to output it to a transmitter of the transponder.

This received initial signal has a time of flight delay caused by the distance between the base station and the transponder. As an approximation the time of flight delay is disregarded for the time-dependent initial frequency of the initial signal since the change in the time-dependent frequency is very slow or is regarded as stepwise. This initial signal received in this way is introduced into the first mixer in the transponder, which amplitude-modulates the initial signal with a high-frequency and constant amplitude modulation frequency, wherein said amplitude modulation frequency is highly pure and stable, in particular. The initial signal is amplitude-modulated in this case. A signal that extends over wide distances and can be evaluated precisely is provided as a result.

One alternative includes the fact that the constant amplitude modulation frequency for the amplitude modulation of the initial signal can oscillate simultaneously or with individual different constant amplitude modulation frequencies. Thus, simultaneously a plurality of high-purity frequencies can be modulated onto the amplitude or successively different fixed high-purity frequencies can be provided for the amplitude modulation. A radar system having a plurality of transponders that transmit on different amplitude modulation frequencies can be used as a result. The amplitude frequencies of the transponders can accordingly be set in each case to an amplitude modulation frequency. The setting of the amplitude modulation frequencies can also be effected automatically by each transponder searching for a free amplitude modulation frequency.

In order to enable an even more precise evaluation of the locating signal, in the transponder a second mixer can be connected upstream of the first mixer. In this embodiment, the second mixer in the transponder is the first to accept the initial signal, where the latter is modulated with a stabilization frequency of the signal, and subsequently forwards a signal modulated with the stabilization frequency to the first mixer. The first mixer can then either transmit the signal back to the base station or forward it to a further mixer of the transponder.

Furthermore, a third mixer of the transponder can be connected downstream of the first mixer, wherein the third mixer accepts the signal from the first mixer and modulates it once again with the stabilization frequency. The third mixer outputs a signal to the transmitter of the transponder. The signal is modulated a second time by the third mixer in the transponder. Overall, in this embodiment, the signal is modulated twice with the same stabilization frequency. As a result, a high quality of the carrier frequency is achieved, such that the locating signal transmitted back can be determined precisely.

In one preferred embodiment it can be provided that the stabilization frequency corresponds approximately to the initial frequency of the initial signal, wherein the stabilization frequency is in the microwave range or in the radio wave range or in the radar wave range or in the meter wave range or in the centimeter wave range. The mixing of the stabilization frequency correspondingly approximately to the original initial frequency of the initial signal ensures a reliable determination of the distance since the locating signal does not contain any ambiguities as a result of artefacts or as a result of noise.

Preferably, fast-sampling analog-to-digital converters are used in the base station in order to analyze the locating signal. The electronic circuit of the base station with fast-sampling analog-to-digital converters is of simple construction.

It can supplementarily be provided that the locating signal is filtered in the base station, in particular is filtered by high-pass filtering or bandpass filtering or low-pass filtering. The filtering makes it possible to isolate the frequency required for the distance and speed determination. In the case of a time-dependent frequency, the filtering can filter time-dependently or filter out a specific frequency band.

Alternatively or supplementarily to the fast-sampling analog-to-digital converters, the filtered locating signal can be analyzed using slow- sampling analog-to-digital converters, as a result of which in particular the data rate is reduced. Just using slow-sampling analog-to-digital converters results in a drastically simplified and cost-effective electronic circuit for the base station. Furthermore, only a low volume of data has to be processed and possibly forwarded. A reduced data rate can advantageously be used in conjunction with a so-called smartphone app and/or a wireless transmission and/or some other computer application.

The locating signal received by the base station can be mixed with a frequency that is lower than the constant amplitude modulation frequency of the amplitude modulation in a second mixer in the base station. As a result, the locating signal is particularly advantageously prepared for the slow sampling by means of analog-to-digital converters.

Furthermore, the locating signal can be self-mixed in a baseband signal for evaluation purposes. Particularly with the use of a plurality of transponders which perform the amplitude modulation with different frequencies, by virtue of the self-mixing the transponders can be determined separately from one another in a very simple manner, and a determined distance to the base station can be assigned to each transponder. Furthermore, approximately a doubled resolution capability with regard to the distance is achieved by virtue of the self-mixing, since the distance axis is extended by a factor of 2 by comparison with traditional radar methods.

In the base station, in a further embodiment, the locating signal, after being received by a first mixer in the base station, can be mixed with a frequency corresponding to the initial frequency of the initial signal or with a lower frequency in order to achieve a better signal processing.

Furthermore, it is possible for the transponder of the radar system for carrying out the method to comprise a transmitter and a receiver for the transmitted signals and also an amplifier. A first mixer in the transponder mixes onto the received initial signal the amplitude modulation frequency by means of a signal source, as a result of which a reliable amplitude modulation is achieved.

One advantageous development includes the fact that a second mixer and preferably a third mixer are connected in the transponder and modulate onto the initial signal the stabilization frequency by means of a further signal source. As a result, the locating signal to be emitted becomes very stable and easily evalulatable in the base station.

The base station of the radar system for carrying out the method comprises a transmitter and a receiver and also a signal source for an initial signal, wherein the first mixer in the base station mixes the received locating signal with an initial frequency of the signal source of the initial signal, and subsequently a filter filters the mixed signal and outputs it to an output. The output can be connected to a computer that samples the signal.

In a further embodiment of the base station, the second mixer in the base station mixes the filtered signal with a further frequency and only afterward passes the signal to the output for evaluation. The sampling rate can be reduced as a result.

Moreover, the invention provides a system comprising a base station of a radar system for carrying out a method, in particular a method according to the invention, comprising a transmitter and a receiver and also a signal source for an initial signal, wherein a first mixer in the base station mixes a received locating signal with a frequency of the signal source, and subsequently a filter filters the mixed signal, and a mobile device with a transponder.

In this case, it can be provided that a second mixer in the base station mixes the filtered signal with a further frequency.

Moreover, the invention provides a use of a method according to the invention or of a system according to the invention for ascertaining the position of a device in a conduit of a conduit system, in particular of a duct.

In this case, it can be provided that the position of the device is used for exposing a lateral duct in the conduit by means of the device.

### BRIEF DESCRIPTION OF THE DRAWINGS

The invention is explained in greater detail below on the basis of two exemplary embodiments with reference to the associated drawings. In the figures:

FIG. 1 shows a schematic side view of a radar system according to the invention for determining a distance of an object,

FIG. 2 shows an embodiment according to the invention of a radar system with an amplitude amplifier, but without mixing of the modulated signal with a frequency,

FIG. 3 shows a frequency analysis of the amplitude-amplified locating signal plus the signal backscattered passively from other objects,

FIG. 4 shows an embodiment according to the invention of a radar system with amplitude modulation,

FIG. 5 shows an embodiment according to the invention of a radar system with amplitude modulation,

FIG. 6 shows a frequency analysis of the amplitude-modulated locating signal plus the signal backscattered passively from other objects,

FIG. 7 shows a frequency analysis of the amplitude-modulated locating signal with subsequent second mixing in the base station,

FIG. 8 shows a frequency analysis of the amplitude-modulated locating signal with subsequent self-mixing and an alternative embodiment of the transponder.

### DETAILED DESCRIPTION OF THE INVENTION

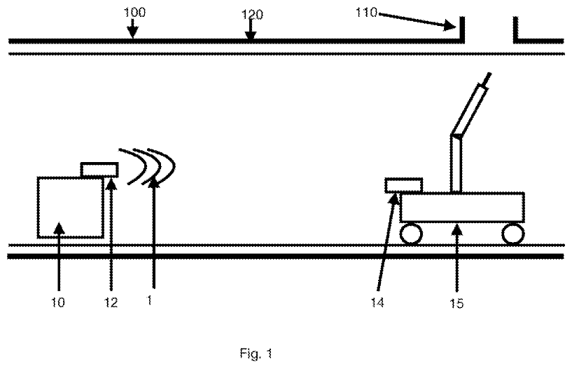

FIG. 1 shows a conduit 100 with a branch junction 110, which has been renovated by means of a tubular liner 120. Furthermore, a radar system 10 according to the invention is arranged in the conduit 100, by means of which radar system the distance of an exposing device 15 can be determined. The radar system 10 comprises a base station 12 and transponders 14 fitted to the device 15.

The base station 12 emits an initial signal 1, which is received by the transponder 14 and is actively modulated in the transponders 14 in order subsequently to be transmitted back to the base station 12.

According to the invention, the locating signal 2 is amplitude-modulated. The modulation is effected for each transponder 14 with a high-purity dedicated amplitude modulation frequency. The amplitude modulation frequency can be a sine or a cosine. The initial frequency of the initial signal can be implemented in a frequency band of 24 GHz ISM. Since the radar system 10 according to the invention has active transponders, it is not limited just to 150 m, as is the case for conventional passive radar systems.

The radar system 10 can emit an initial signal 1 comprising a linearly frequency-modulated wave. Furthermore, the radar system 10 is embodied as an SISO, AoA, digital beamforming, MIMO or other imaging radar system. The starting bandwidth of the radar system 10 can be a plurality of megahertz.

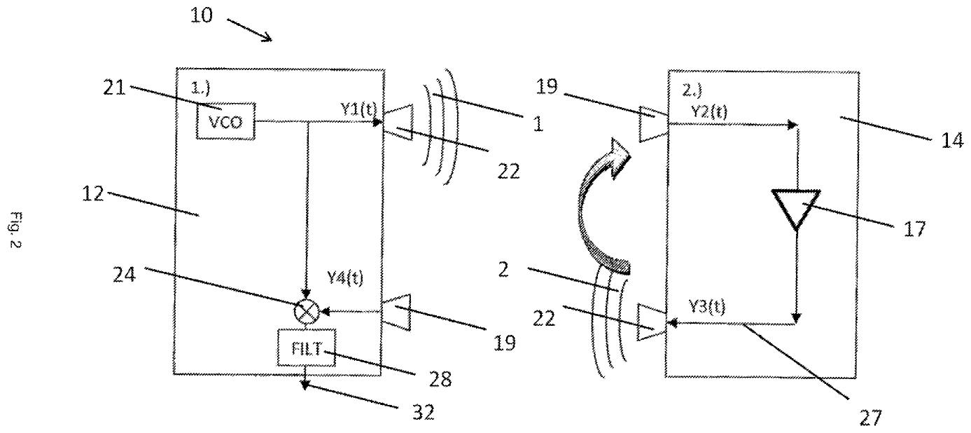

FIG. 2 shows a very simple radar system 10, in which the transponder 14 merely amplifies the initial signal 1 by means of an amplifier 17. The base station 12 comprises a signal source 21 for the initial signal 1. The signal source 21 is a VCO oscillator (Voltage Controlled Oscillator), which generates a signal having an initial frequency fuW. The initial signal 1 is transmitted in the direction of the transponder 14 by means of a transmitter 22. The transponder 14 receives the initial signal 1 with a receiver 19. In the transponder 14, the initial signal 1 is amplified by the amplifier 17 and forwarded to a transmitter 22 of the transponder 14, which transmits the locating signal 2 thus generated back to a receiver 19 of the base station 12. The base station 12 receives the locating signal 2 and evaluates it. For this purpose, the locating signal 2 is forwarded to a first mixer 24, where it is mixed with the initial frequency fuW of the signal source 21 of the initial signal 1 and forwarded to a filter 28. The filter 28 can be a high-pass filter or a bandpass filter or a low-pass filter which filters the locating signal 2 out of a signal superposed with noise at the receiver 19 of the base station 12. After filtering, the filtered signal is conducted to an output 32 of the base station 12 for evaluation, where it can be analyzed for example by means of a computer in respect of movements, distances, oscillations and directions of movement of the objects 15.

The initial signal 1 can be calculated as follows if the temporal dependence of the initial frequency is general, wherein y1(t) is the initial signal, A is the amplitude, ω is the frequency, and t and respectively t′ are time. This calculation formula also applies to temporally dependent frequencies ω(t) that are not linear.

y₁(t)=A·cos(∫_{∞}^{t}ω(t′)·dt′)

In the case of slow frequency variations compared with the period duration of the initial signal 1, the emitted initial signal 1 can also approximately be subject to the following relationship, wherein a linear relationship between the time-dependent initial frequency ω(t) and time t is present. Furthermore, a phase shift φ0 is contained, which also arises as a result of the integration of the general formula for y1(t).

y₁(t)=A·cos(ω(t)·t+σ₀)

The initial signal 1 emitted by the transmitter 22 of the base station 12, said initial signal following a wave function y1(t), is received by the receiver 19 of the transponder 14 and includes a time of flight delay Tof from just the distance between the transponder 14 and the base station 12. In this case, the receiver 19 of the transponder 14 receives a wave function y2(t) with an attenuated amplitude B, which can be described as follows.

y₂(t)=B·cos(ω(t)·(t−T_{oF})+φ₀)

Since the change in the time-dependent initial frequency ω(t) can be regarded as very slow or stepwise, the argument of ω(t) is approximately not shifted in time by the time of flight delay ToF. The argument simply remains t. The transponder 14 of the embodiment in accordance with FIG. 2 merely amplifies the received signal with the wave function y2(t) and emits a locating signal 2 having an altered amplitude, which, after a renewed time of flight delay Tof and a damping of the amplitude, is received by the receiver 19 of the base station 12 with the wave function y4(t) having an amplitude D and a doubled time of flight delay Tof. The argument of ω(t) can likewise be regarded as approximately not shifted in time by the time of flight delay.

y₂₄(t)=D·cos(ω(t)·(t−2·T_{oF})+φ₀)

In the base station 12, the received locating signal 2 is multiplied by the initial signal 1 by the first mixer 24. The multiplication proceeds on the basis of trigonometrical theorems with respect to the following wave function.

$${y}_{1} ( t ) \cdot {y}_{4} ( t ) = \frac{A \cdot D}{2} \cdot [ cos ( 2 ω ( t ) \cdot {T}_{oF} ) + cos ( 2 \cdot ω ( t ) \cdot ( t - {T}_{oF} + 2 {φ}_{0} ) ]$$

Afterward, the right-hand term is filtered out by low-pass filtering, such that a filtered function is output to the output 32 for evaluation. The following function is particularly easy to analyze since unnecessary signal components and noise have been filtered out.

$$filt ( {y}_{1} ( t ) \cdot {y}_{4} ( t ) ) = \frac{A \cdot D}{2} \cdot cos ( 2 ω ( t ) \cdot {T}_{oF} )$$

By virtue of the constant time of flight delay ToF, the wave functions oscillate harmonically owing to the time-dependent frequency variation of the initial frequency ω(t). In the case of different distances between the transponder 14 and the base station 12, the signal oscillates at different speeds in the case of a linear variation of the initial frequency ω(t). Moreover, an FMCW radar system can process abrupt frequency changes. In the case of a superposition of a plurality of objects 15 with transponders 14, the linear and other components of the signals are separated from one another by a Fourier transformation, thereby enabling an evaluation of the distance and the speed of the individual objects.

If a linear change in the initial frequency ω(t) is assumed, a temporally linear relationship is obtained, wherein Δω represents a change in frequency and ΔT represents a change in time.

$$ω ( t ) = \frac{Δ ω}{Δ T} \cdot t$$

The wave function y1(t) of the initial signal 1 can be simplified as a result. There follows after an integration of the linear relationship

$${y}_{1} ( t ) = A \cdot cos ( {\int }_{∞}^{t} ω ( {t}^{′} ) \cdot {dt}^{′} ) = A \cdot cos ( \frac{Δ ω}{2 Δ T} \cdot {t}^{2} ) .$$

Furthermore, the following relationship results for the wave function y4(t) of the locating signal 2 received by the base station 12.

$${y}_{4} ( t ) = D \cdot cos ( \frac{Δ ω}{2 Δ T} \cdot {( t - 2 {T}_{oF} )}^{2} ) = D \cdot cos ( \frac{Δ ω}{2 Δ T} \cdot ( {t}^{2} - 4 {T}_{oF} \cdot t + 4 {T}_{oF}^{2} ) )$$

The simplified wave functions y1 and y4 are multiplied together again and subsequently filtered, resulting in the following relationship according to the above explanation of the filtering process.

$$filt ( {y}_{1} ( t ) \cdot {y}_{4} ( t ) ) = \frac{A \cdot D}{2} \cdot cos ( 2 {\underbrace{\frac{Δ ω}{Δ T} \cdot t}}_{ω ( t )} \cdot {T}_{oF} - 2 \frac{Δ ω}{Δ T} \cdot {T}_{oF}^{2} )$$

The first term in the argument of the cosine function represents the relationship of the stepwise FMCW method. Supplementarily to the term of the stepwise FMCW method, the second term represents the distance-dependent phase shift, which remains in a steady state in the case of an invariable distance despite the linear time dependence of the initial frequency. This is the case for a stationary object 15.

If the device 15 is in motion, however, and has a speed, an acceleration or an oscillatory movement, then the time of flight delay Tof is no longer in the steady state, but rather likewise follows a temporal dependence. In the simplest case, this can be linear as follows, wherein v is a constant speed and c0 is the speed of light.

$${T}_{oF} = \frac{v \cdot t}{{c}_{0}}$$

For a moving device 15, the filtered multiplication of the wave functions that is passed to the output 32 for evaluation results as

$$filt ( {y}_{1} ( t ) \cdot {y}_{4} ( t ) ) = \frac{A \cdot D}{2} \cdot cos ( 2 \frac{Δ ω}{Δ T} \cdot \frac{v}{{c}_{0}} \cdot {t}^{2} \cdot ( 1 - \frac{v}{{c}_{0}} ) )$$

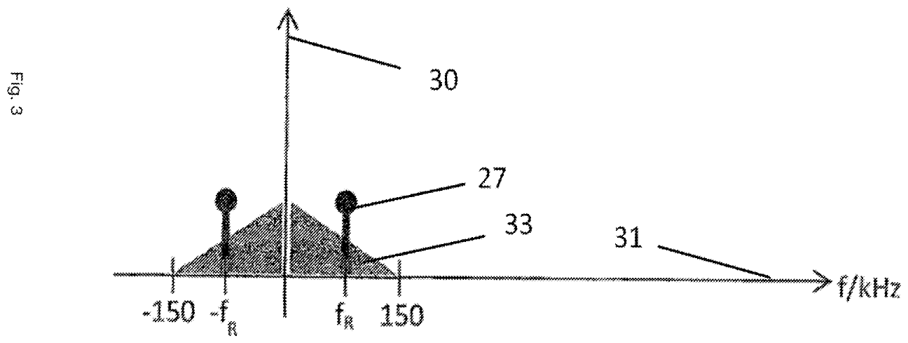

FIG. 3 shows a frequency analysis of the multiplied signal, said frequency analysis being achieved by the radar system 10 of the embodiment in FIG. 2. The vertical axis 30 indicates the amplitude strength and the horizontal axis 31 indicates the magnitude of the frequency in hertz. The radar system 10 in FIG. 2 does not generate an amplitude modulation with a high-purity periodic function according to the invention.

If the radar system is now operated in a 24 GHz ISM frequency band, then the linear variation of the initial frequency ω(t) can take place with a bandwidth of 250 MHz. The resultant resolution arises from the following relationship, wherein ΔR is the resolution pattern in a spatial direction and Δf is a change in a frequency.

$$Δ R = \frac{{c}_{0}}{2 Δ f}$$

The number of oscillations while traversing the frequency ramp with ω(t) in the case of a 24 GHz ISM frequency band follows the following relation, wherein NR indicates the number of oscillations and R indicates a distance.

$${N}_{R} = \frac{R}{Δ R}$$

By way of example, in the case of objects at a distance of 1.8 km from the base station 12, there are up to 3000 oscillations per frequency ramp. Given a ramp repetition frequency which is high enough, and which can be 50 Hz, for example, in order to be able to cleanly resolve movements of the device 15 on the basis of the Doppler effect, a maximum frequency of 150 kHz can be calculated for passive radiating surfaces of the objects. Passive radiating surfaces are surfaces of the objects and of the surroundings thereof which radiate back the radar signals and they arrive at the base station 12 in addition to the locating signal 2 radiated back actively by the transponder 14. These signals 33 radiated back passively are represented as a triangular area in FIG. 3 since these passive reflectors are distributed approximately homogenously and they generate a continuous spectrum from 0 Hz to 150 Hz, the amplitude of this signal 33 decreasing.

If, then, in accordance with the embodiment in FIG. 2, the locating signal 2 is not modulated with an amplitude modulation and a high-purity frequency, rather the amplitude is merely amplified, the result, as illustrated in the frequency analysis in FIG. 3, is a doubled transmitted-back peak-like signal 27 having discrete distance-dependent frequencies fR which lies in the signal 33 radiated back passively. This results in a superposition of the signals 27, 33 and thus in an evaluation of the distance that is made more difficult. In particular, as the distance increases, the amplitude of the discrete frequency fR can fall below the amplitude of the backscattered signal 33. Such a disadvantageous effect occurs for example in the case of multiply reflective surroundings such as ducts, since there the duct walls constantly reflect owing to the high roughness. This can be a particular hindrance if there is a desire to recognize a duct robot using a radar system.

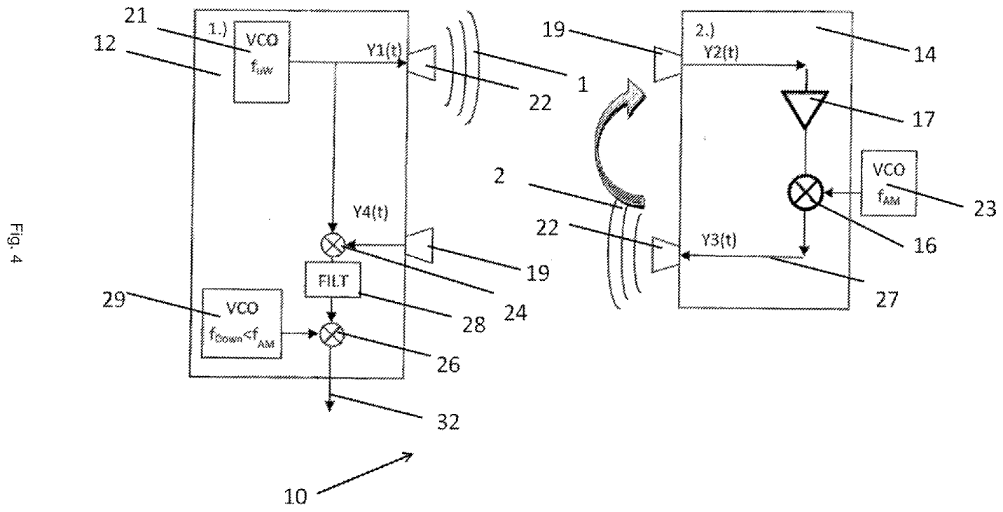

A further embodiment of the radar system 10 is illustrated in FIG. 4. In principle, in this embodiment, the initial signal 1 is likewise transmitted by a transmitter 22 of the base station 12 to a receiver 19 of the transponder 14, and the locating signal 2 is transmitted back. In the transponder 14, a first mixer 16 is connected downstream of the amplifier 17 and amplitude-modulates the wave function y2(t) by means of a signal source 23. The signal source 23 impresses a frequency fAM on the amplitude of the wave function y2(t), which results in an altered wave function y3(t) with respect to the embodiment in FIG. 2. The new wave function y3(t) follows the relationship

y₃(t)=k·B·cos(ω(t)·(t−T_{oF})+φ₀)·cos(ω_{AM}·t+φ_{AM})

In this case, k is a factor by which the new amplitude B is increased or decreased. Furthermore, ωAM is the frequency of the amplitude modulation at which the amplitude oscillates, and ϕAM is the phase shift of the amplitude modulation. This amplitude modulation frequency fAM and also the factor k for the amplitude modulation can differ in magnitude for different objects 15 with different transponders 14.

The receiver 19 of the base station 12 receives a wave function y4(t)

y₄(t)=D·cos(ω(t)·(t−2·T_{oF})+φ₀)·cos(ω_{AM}·(t−T_{oF})+φ_{AM})

which is altered according to the amplitude modulation. As in the embodiment in FIG. 2, the wave function y4(t) is mixed with the initial signal 1 by the first mixer 24 and then filtered by the filter 28. The signal that arises as a result of the mixing is a product of two harmonic functions and has the following form.

$$filt ( {y}_{1} ( t ) \cdot {y}_{4} ( t ) ) = \frac{A \cdot D}{2} \cdot cos [ 2 ω ( t ) \cdot {T}_{oF} ] \cdot cos [ {ω}_{AM} \cdot ( t - {T}_{oF} ) + {φ}_{AM} ]$$

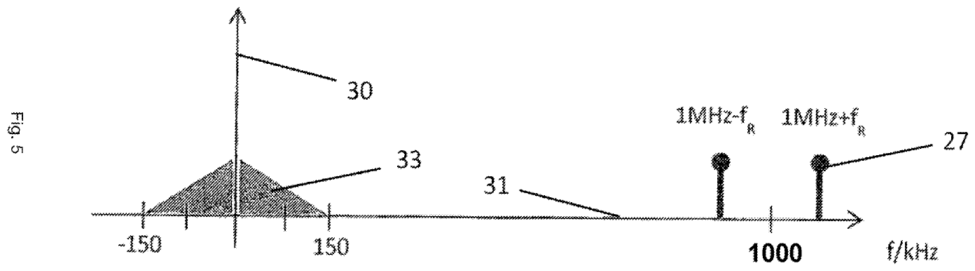

The frequency analysis of the received locating signal 2 is illustrated in FIG. 5. The two peak-like transmitted-back doubled signals 27 have been shifted out of the passive signal 33 along the frequency axis 31 around the amplitude modulation frequency fAM and have a frequency component which includes a distance-dependent frequency fR, which is firstly subtracted from the amplitude modulation frequency fAM and secondly added thereto, thus giving rise to two signal peaks 27 around the amplitude modulation frequency fAM. As a result, even in the case of very large distances the amplitudes of the signals 27 are not superposed by the amplitude of the noise of the signal 33.

Subsequently, for the purpose of signal processing, as illustrated in FIG. 4, in a second mixer 26 in the base station 12, a signal from a signal source 29 for a sampling can be modulated onto the filtered signal. The signal modulated in this way has a frequency fdown that is lower than the modulation frequency fAM. As a result, sampling of the signal after it has been transmitted to the output 32 can be simplified because the data rate can be reduced by means of slow analog-to-digital converters.

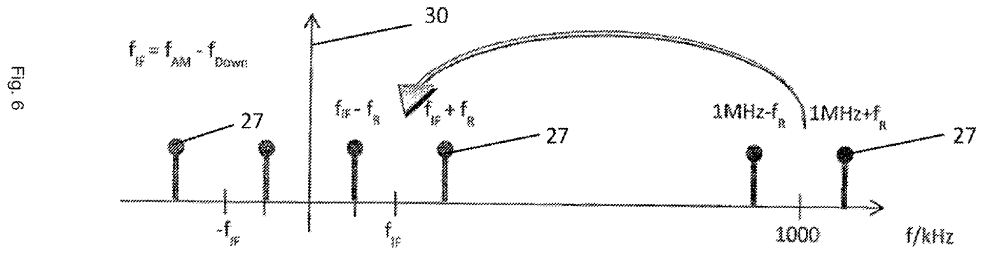

Such a frequency analysis of the signal processing is illustrated in FIG. 6, which shows the mixing of the wave function y4(t) by the second mixer 26 and the impressing of the frequency fdown. In this case, the signals 27 are drawn back again to a range with a low frequency, the signals 27 doubling around the starting frequency of the second mixer 26 in the base station 12 by way of the distance-dependent frequency fR.

Alternatively, for signal processing purposes, the second mixer 26 and the signal source 29 can be dispensed with, wherein the signal transmitted to the output 32 then has to be analyzed by means of fast analog-to-digital converters.

A third alternative for a subsequent treatment for the signal processing of the filtered signal includes just the use of slow analog-to-digital converters, but without the mixing with a slow frequency fdown by means of a signal source 29.

A fourth alternative for the subsequent signal processing of the filtered signal includes a self-mixing of the signal in a baseband signal and a sampling of the signal with very low sampling rates. In this case, firstly only the relevant frequency band around fAM is bandpass-filtered. In particular, frequencies in the lower frequency range but also higher frequencies are filtered out as a result. The self-mixing results in the following expression, the expression containing, read from left to right, a DC component, the pure distance information in the argument of a harmonic function with the frequency 2fR but with a factor of 2 compared with the traditional radar equation, the doubled amplitude modulation frequency fAM and two discrete signal peaks 27 with respect to the doubled amplitude modulation frequency fAM on account of the amplitude modulation with the locating signal 2.

$$\begin{matrix}{[ filt ( {y}_{1} ( t ) \cdot {y}_{4} ( t ) ) ]}^{2} = {( \frac{A \cdot D}{2} \cdot cos [ 2 ω ( t ) \cdot {T}_{oF} ] \cdot cos [ {ω}_{AM} \cdot ( t - {T}_{oF} ) + {φ}_{AM} ] )}^{2} \\ = \frac{( A \cdot D ) 2}{4} \cdot {( cos [ 2 ω ( t ) \cdot {T}_{oF} ] )}^{2} \cdot ( cos [ {ω}_{AM} \cdot ( t - {T}_{oF} ) + \\ {{φ}_{AM} ] )}^{2} \\ = \frac{{( A \cdot D )}^{2}}{8} \cdot ( 1 + cos [ 4 ω ( t ) \cdot {T}_{oF} ] ) \cdot ( 1 + cos [ 2 \cdot {ω}_{AM} \cdot \\ ( t - {T}_{oF} ) + {φ}_{AM} ] ) \\ = \frac{{( A \cdot D )}^{2}}{8} \cdot ( 1 + cos [ 4 ω ( t ) \cdot {T}_{oF} ] + cos [ 2 \cdot {ω}_{AM} \cdot ( t - {T}_{oF} ) + \\ {φ}_{AM} ] + cos [ 4 ω ( t ) \cdot {T}_{oF} ] \cdot cos [ 2 \cdot {ω}_{AM} \cdot ( t - {T}_{oF} ) + {φ}_{AM} ] )\end{matrix}$$

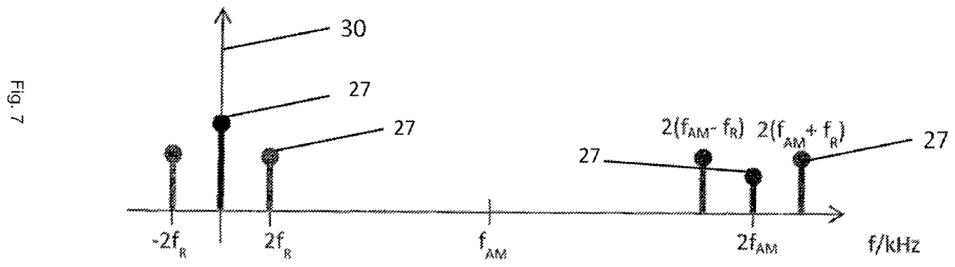

FIG. 7 shows the frequency analysis of the self-mixing, the distance-dependent frequency fR being determined by the filtering of the high-frequency frequencies by means of a simple data acquisition. A doubled resolution capability is achieved by means of the self-mixing because the distance axis is extended by a factor of 2 by comparison with other radar methods.

In order to simplify the following calculations, it is assumed that only one transponder 14 in the radar system 10 communicates with the base station 12. The phase angle of the mixed amplitude-modulated locating signal 2 of the base station 12 is not known; moreover, fluctuations of the high-purity amplitude modulation frequency can occur on account of component tolerances.

However, the emitted frequency can be calculated on the basis of the doubled signal 27 transmitted back, by means of the averaging of the two distance-dependent frequencies fR and -fR. Furthermore, the distance from the base station 12 to the transponder 14 and thus to the object 15 can be calculated by way of the difference between the two distance-dependent frequencies fR and -fR of the two peak-like signals 27. The following relationship can be used for this purpose, wherein fright indicates the frequency of the right peak and fleft indicates the frequency of the left peak.

$$R = \frac{{c}_{0}}{4 \cdot Δ f / Δ T} \cdot ( {f}_{right} - {f}_{left} )$$

The Doppler effect and/or the phase rotation which can arise on account of small movements of the object 15 are determined by the measurement of the phase difference Δϕ(t) between the two signals 27 transmitted back, wherein ϕright(t) indicates the phase of the right peak and ϕleft(t) indicates the phase of the left peak.

Δϕ(t)=f_{right}(t)−f_{left}(t)

A further embodiment includes a plurality of transponders 14 used with just one base station 12. In this case, each transponder 14 amplitude-modulates with a dedicated amplitude modulation frequency fAM,i, wherein i is the index of the respective transponder 14 where i=≈1, 2, 3 . . . N. The respective amplitude modulation frequencies fAM,i fAM differ from one another in their phase angle and the frequencies, but they are preferably distributed around the frequency fAM. In order that the objects can be reliably differentiated, the distances R must differ at least by one to two times the distance resolution ΔR. It is only if these conditions are met that the left and right peaks of the signal 27 of the individual transponders 14 can be unambiguously differentiated from one another. Otherwise, the peaks of the signals 27 of the different transponders 14 merge and can therefore no longer be assigned to the respective transponders 14.

If the locating signal is then self-mixed for evaluation in accordance with the fourth alternative of the signal processing, the transponder systems 14 can operate with significantly different amplitude modulation frequencies fAM,i. These amplitude modulation frequencies fAM,i can include the multiple of the fundamental amplitude modulation frequencies fAM. Furthermore, the self-mixing results in coupled multiplication terms between the individual transponders 14, the multiplication terms of the different amplitude modulation frequencies fAM,i being manifested with multiples of the fundamental amplitude modulation frequencies fAM. Therefore, they are easy to filter out, such that the uncoupled multiplication terms are mixed into the low frequency band and are superposed there with the signals of the other transponders 14. If all of the transponders 14 were operated with the same amplitude modulation frequencies fAM, so-called “ghost objects” would arise which do not represent real interference.

Furthermore, the base station 12 can be either an SISO system having preferably one TX antenna and one RX antenna or an imaging MIMO system. The use of a corresponding system presupposes that in each case only one of the four signal processing methods above can be used.

Alternatively, instead of a linear frequency variation that is typical in a radar system, some other modulation method of the kind that are customary in conventional communication systems can be used in the base station.

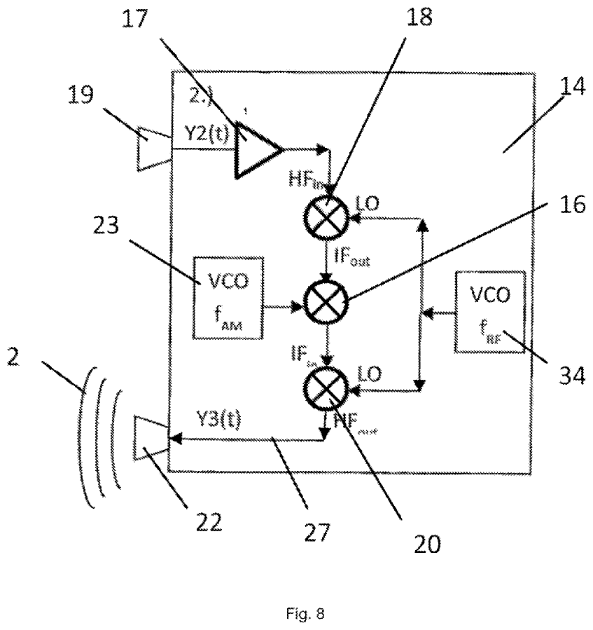

FIG. 8 illustrates an alternative transponder 14. The transponder 14 mixes the wave function y2(t), after amplification by the amplifier 17, with a stabilization frequency fRF by means of a second mixer 18, said stabilization frequency being generated by a signal source 34. After being mixed in the second mixer 18, the signal is forwarded to the first mixer 16 in the transponder 14, where the amplitude modulation is effected. After the amplitude modulation, the signal is forwarded further to a third mixer 20, where it is mixed with the stabilization frequency fRF in a repeated manner and as wave function y3(t) is transmitted by the transmitter 22 as locating signal 2 to the base station 12. The stabilization frequency fRF is in the microwave range and has approximately the same frequency fuW as the initial signal 1.

1. A method for locating a movable device in a conduit system by means of a radar system comprising a base station and a transponder fitted to the device, characterized by the following steps:
transmitting a periodic initial signal having a temporally variable initial frequency by means of the base station,
receiving the periodic initial signal by means of the transponder fitted to the device,
modulating the initial signal in the transponder in order to generate a locating signal, such that the amplitude of the initial signal oscillates periodically with a fixed amplitude modulation frequency,
transmitting the generated periodic locating signal by means of the transponder,
receiving the locating signal by means of the base station, and
evaluating the locating signal by means of an analysis for periodic signals in order to locate the device in the conduit system, wherein the distance between the device and the base station is determined.

2. The method of claim 1, characterized in that the position of the device is controlled and regulated depending on the evaluation of the locating signal.

3. The method of claim 1, characterized in that the device comprises an electric drive, a drilling or milling head, an illuminant for generating radiation for curing a tubular liner and/or a camera.

4. The method of claim 1, characterized in that the modulation is effected by a first mixer in the transponder, which accepts the initial signal and modulates it with a high-frequency constant amplitude modulation frequency in order to output it to a transmitter of the transponder.

5. The method of claim 4, characterized in that a second mixer (18) is connected upstream of the first mixer (16) in the transponder and accepts the initial signal (1) and modulates it with a stabilization frequency and forwards a signal to the first mixer (16).

6. The method of claim 5, characterized in that a third mixer (20) of the transponder is connected downstream of the first mixer (16), which accepts the signal (4) from the first mixer (16) and modulates it once again with the stabilization frequency, wherein the third mixer (20) outputs a signal to the transmitter (22) of the transponder (14).

7. The method of claim 1, characterized in that the distance and speed of the device are determined by evaluating the locating signal, wherein preferably the speed direction is determined.

8. The method of claim 1, characterized in that the locating signal, after being received by a first mixer in the base station, is mixed correspondingly with the initial signal.

9. The use of the method of claim 1 for ascertaining the position of a device in a conduit of a conduit system, in particular of a duct.

10. The use as claimed in claim 9, wherein the position of the device is used for exposing a lateral duct in the conduit by means of the device.

11. A system comprising a base station (12) of a radar system (10) for carrying out a method in particular as claimed in any of the preceding claims, comprising a transmitter (22) and a receiver (19) and also a signal source (21) for an initial signal (1), characterized in that a first mixer (24) in the base station (12) mixes a received locating signal (2) with a frequency of the signal source (21), and subsequently a filter (28) filters the mixed signal, and a mobile device with a transponder (14).

12. The system of claim 11, characterized in that a second mixer (26) in the base station (12) mixes the filtered signal with a further frequency.

13. The use of a method of claim 12 for ascertaining the position of a device in a conduit of a conduit system, in particular of a duct.

14. The use as claimed in claim 13, wherein the position of the device is used for exposing a lateral duct in the conduit by means of the device.
